(19) United States
(12) Patent Application Publication
(10) Pub. No.: US 2005/0284384 A1
(43) Pub. Date: Dec. 29, 2005

(54) Feeder EZ, feeder hanging or suspension system

(76) Inventors: Donny Judson Arsenault, Ocoee, FL (US); Nathan Richard Dixon, Auburndale, FL (US); Dennis Oneil Crowe, St. Cloud, FL (US)

Correspondence Address: DONNY ARSENAULT, 419 VANDERGRIFT DRIVE, OCOEE, FL, 34761, US

(21) Appl. No.: 10/776,878

(22) Filed: Jun. 28, 2004

(51) Int. Cl. A01K 61/02

(52) U.S. Cl. 119/52.1

(57) ABSTRACT

Feeder EZ is the only Game feeder hanging system that can hold a 30 or 55 gallon drum dispensing system containing up to 300 lbs of grain or feed from the (Trunk) of a single tree. The only other feeder hanging system that is used on a tree is done so by hanging a 10 gallon container, holding no more then 30 lbs of feed from the branch of a tree using a rope and pulley system. Therefore making Feeder EZ hanging system more productive as it can hold larger containers on the tree because it does not require the use of branches and ropes. Instead it uses the main stability of the tree which is the trunk itself It is made of light weight aluminum and can be installed in seconds by one person.

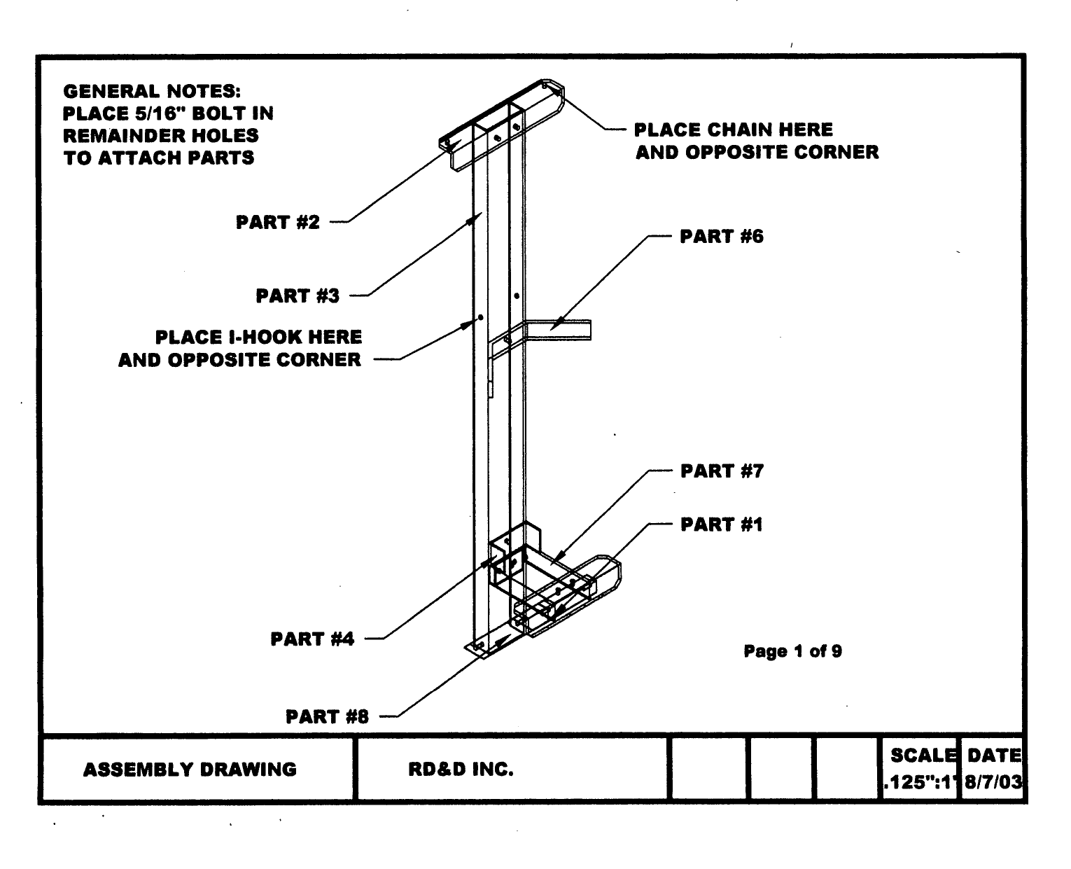

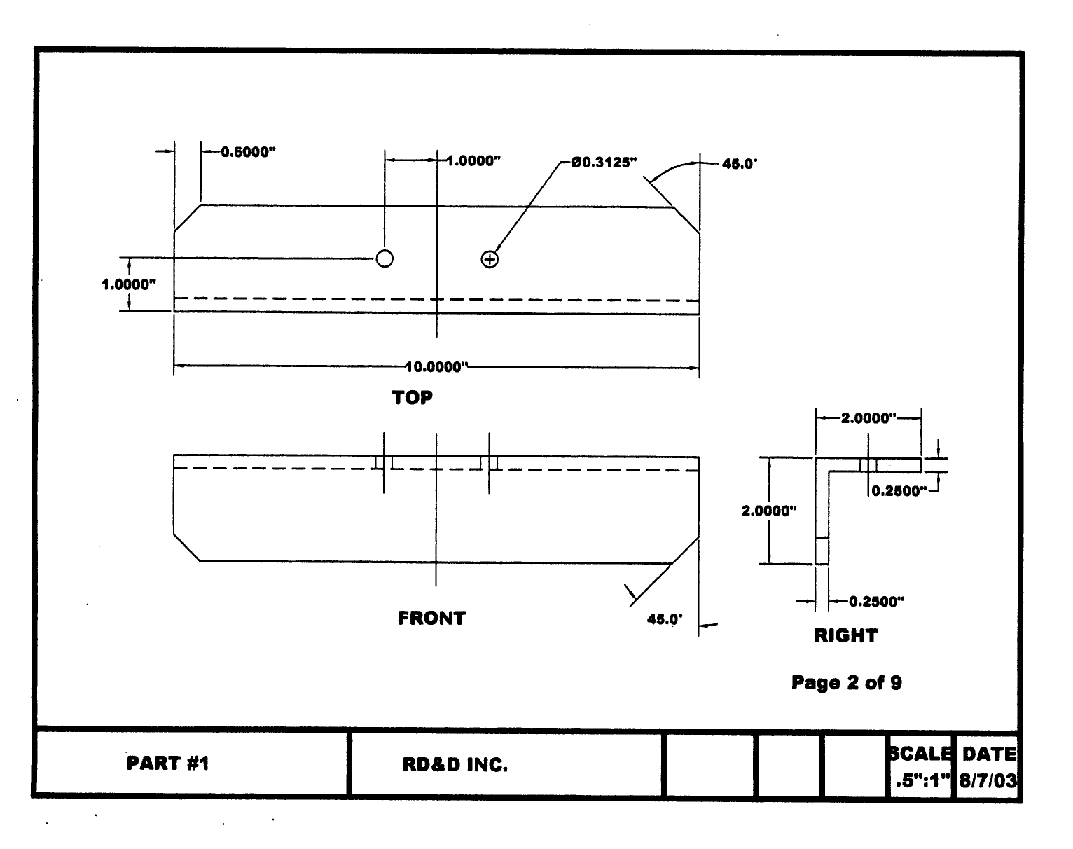

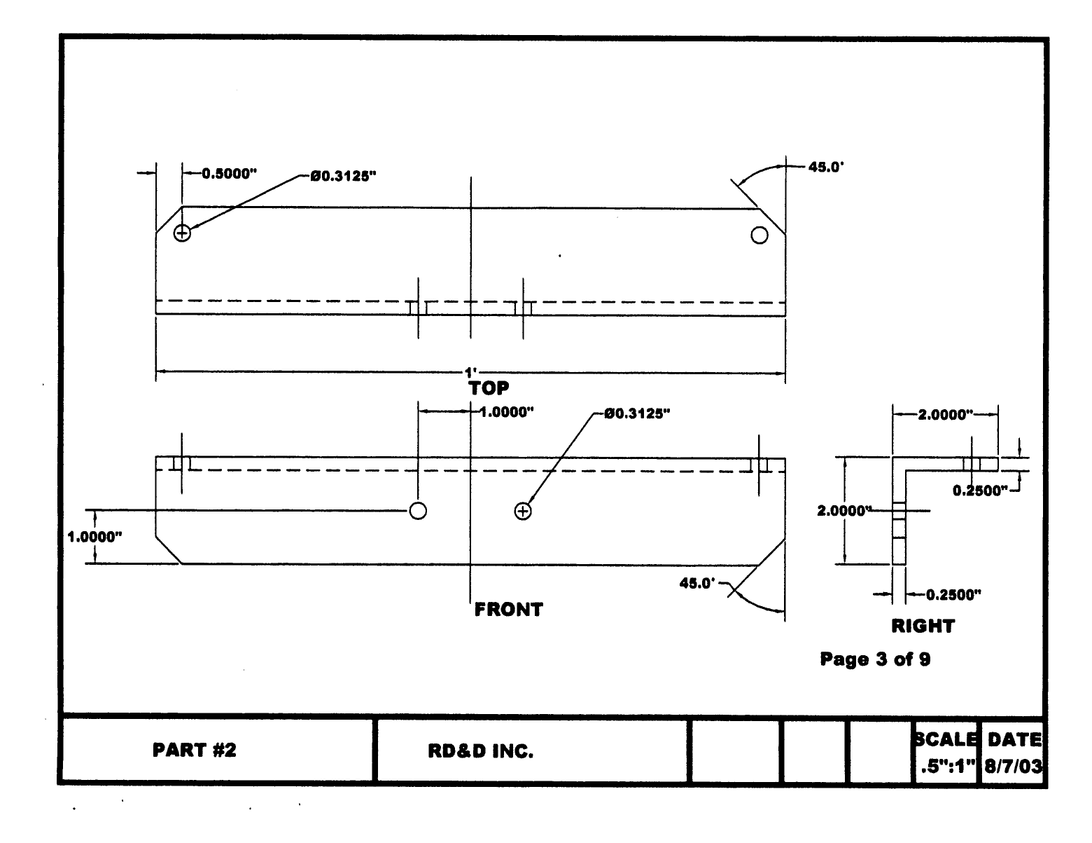

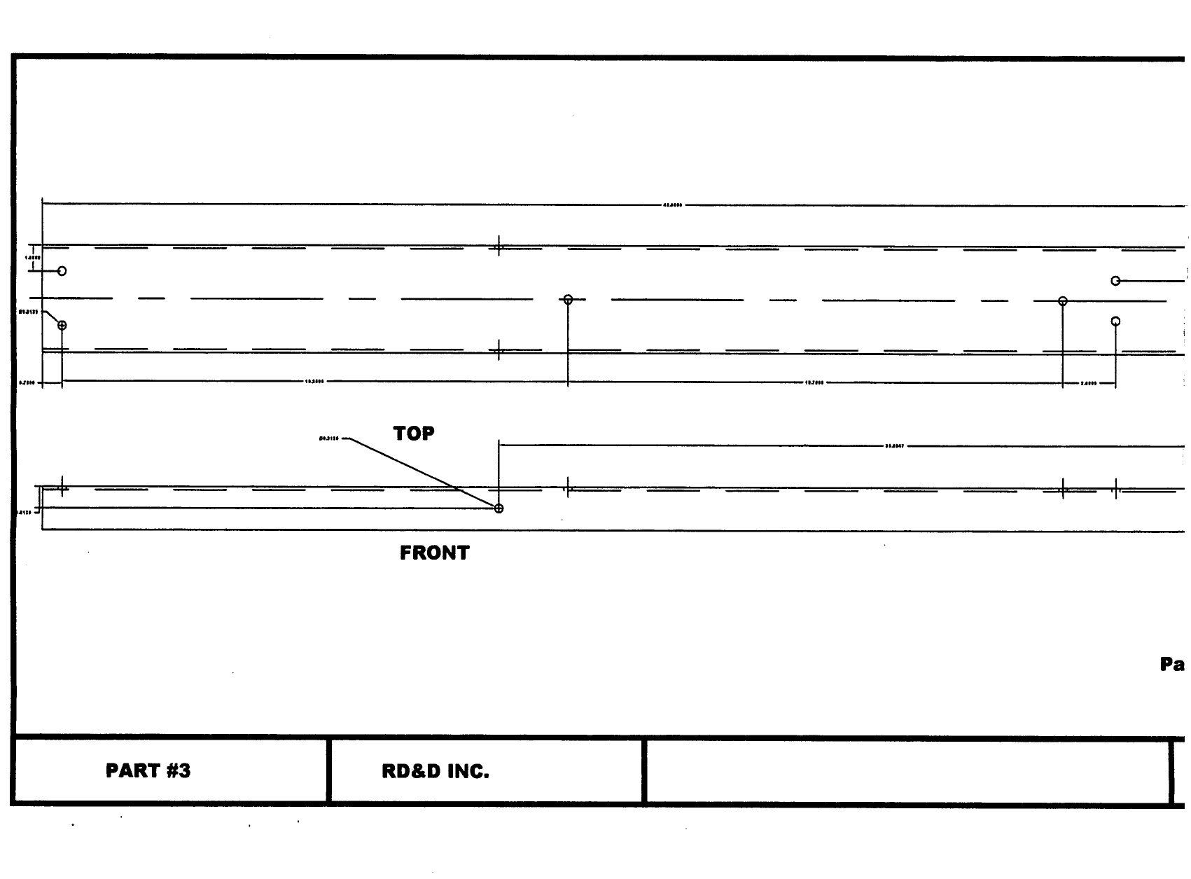

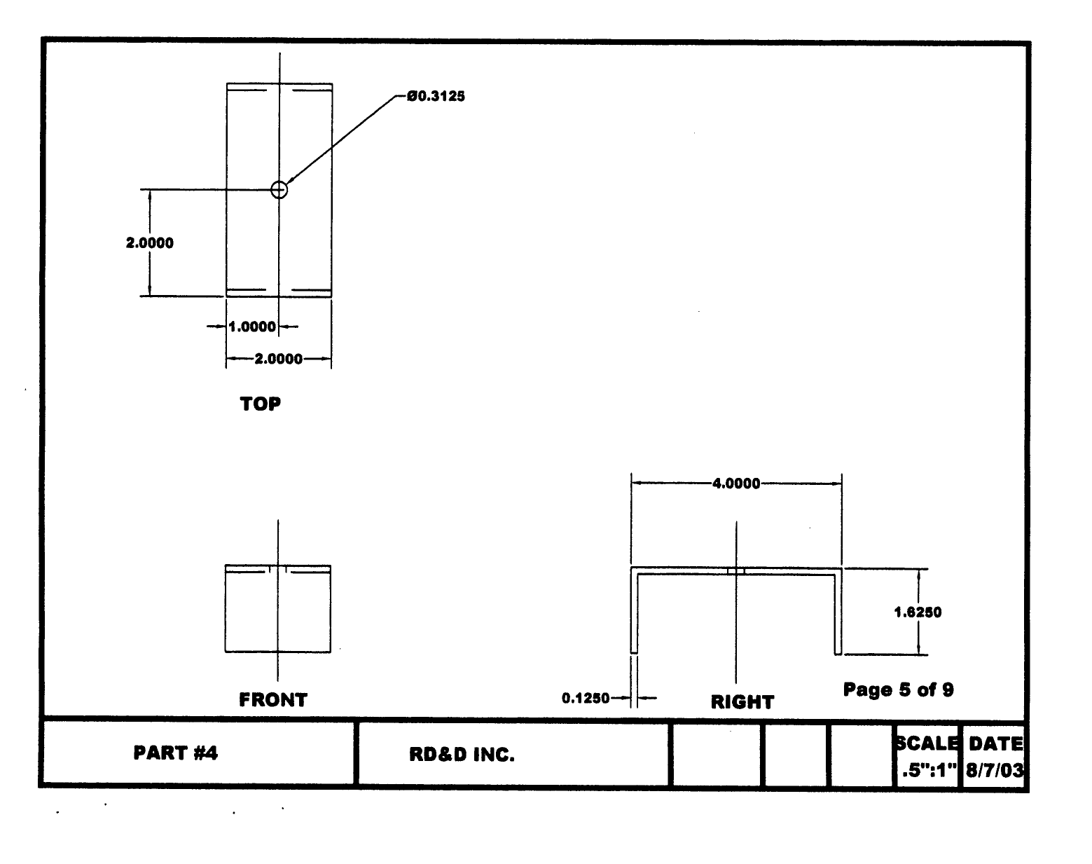

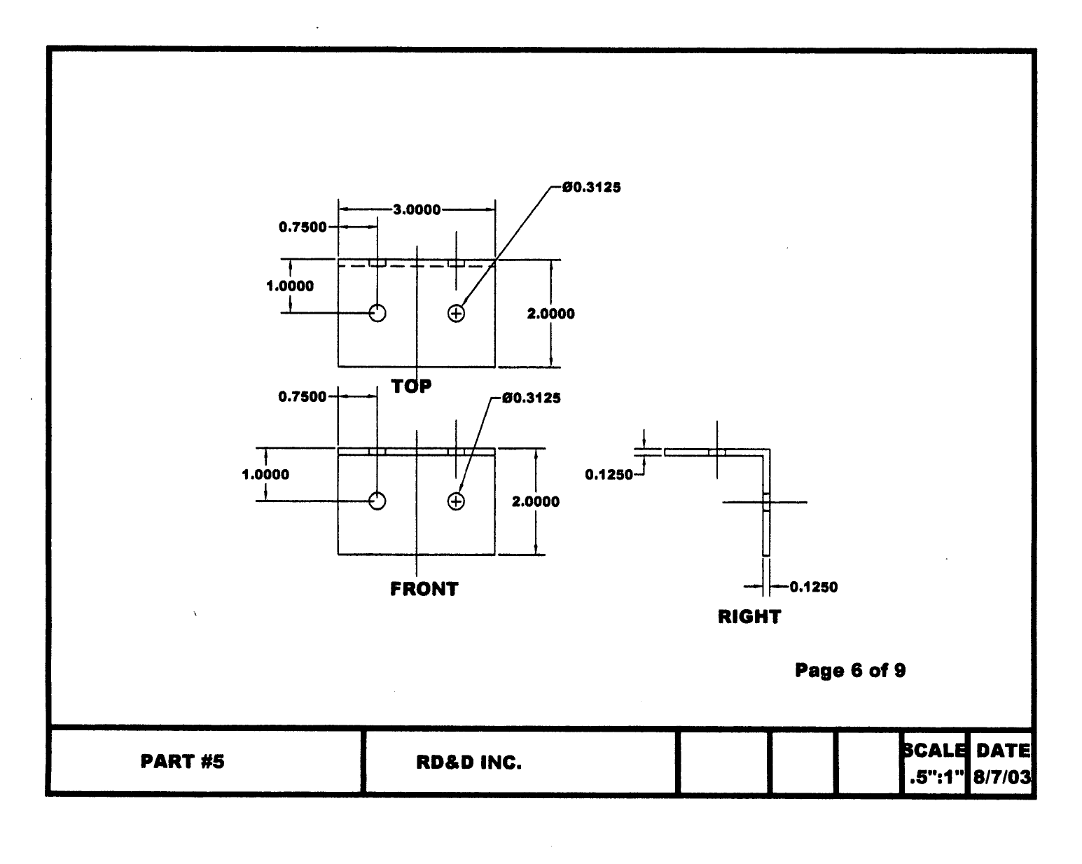

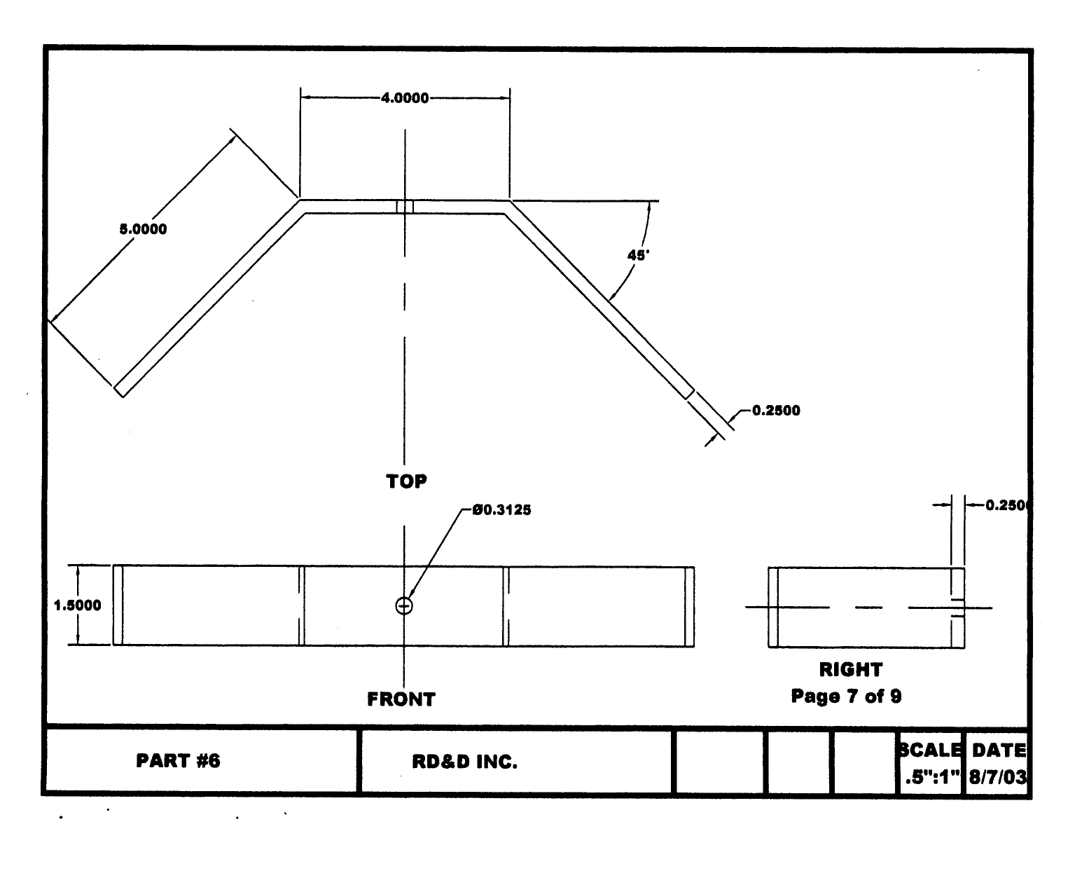

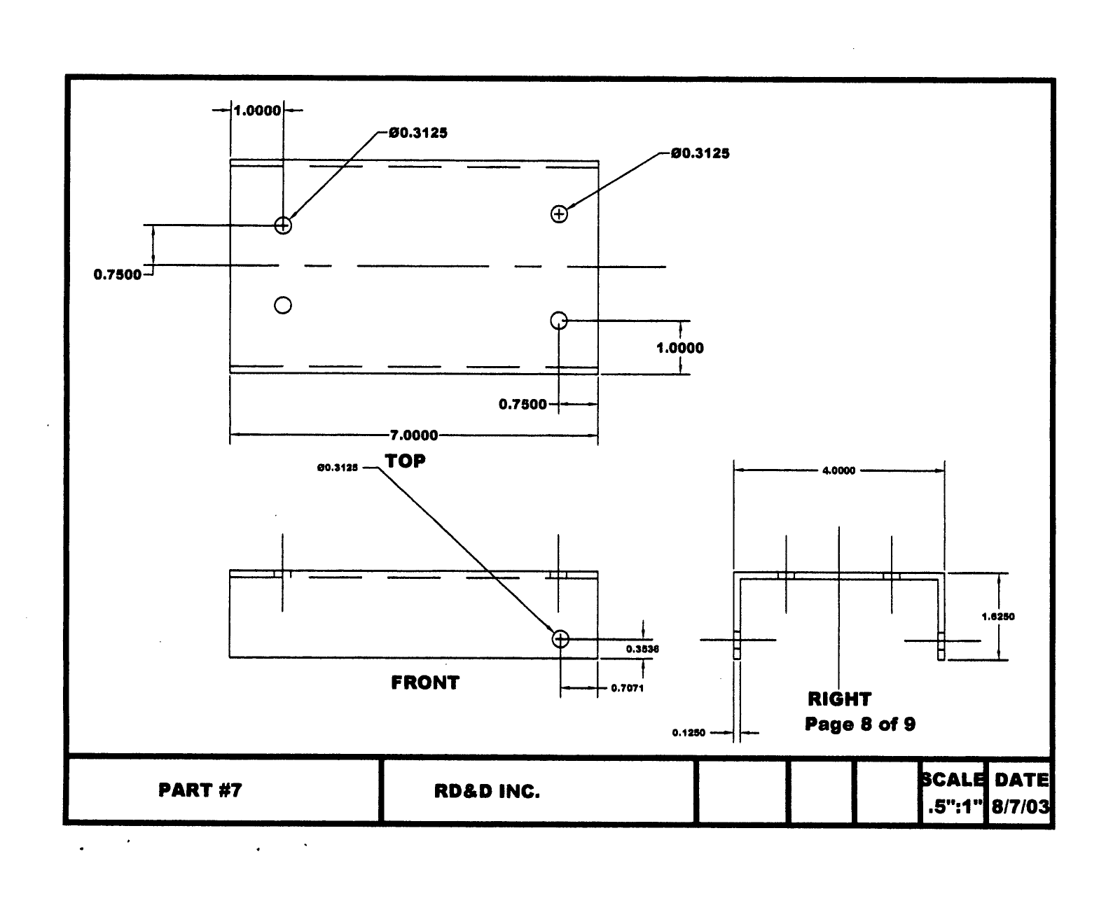

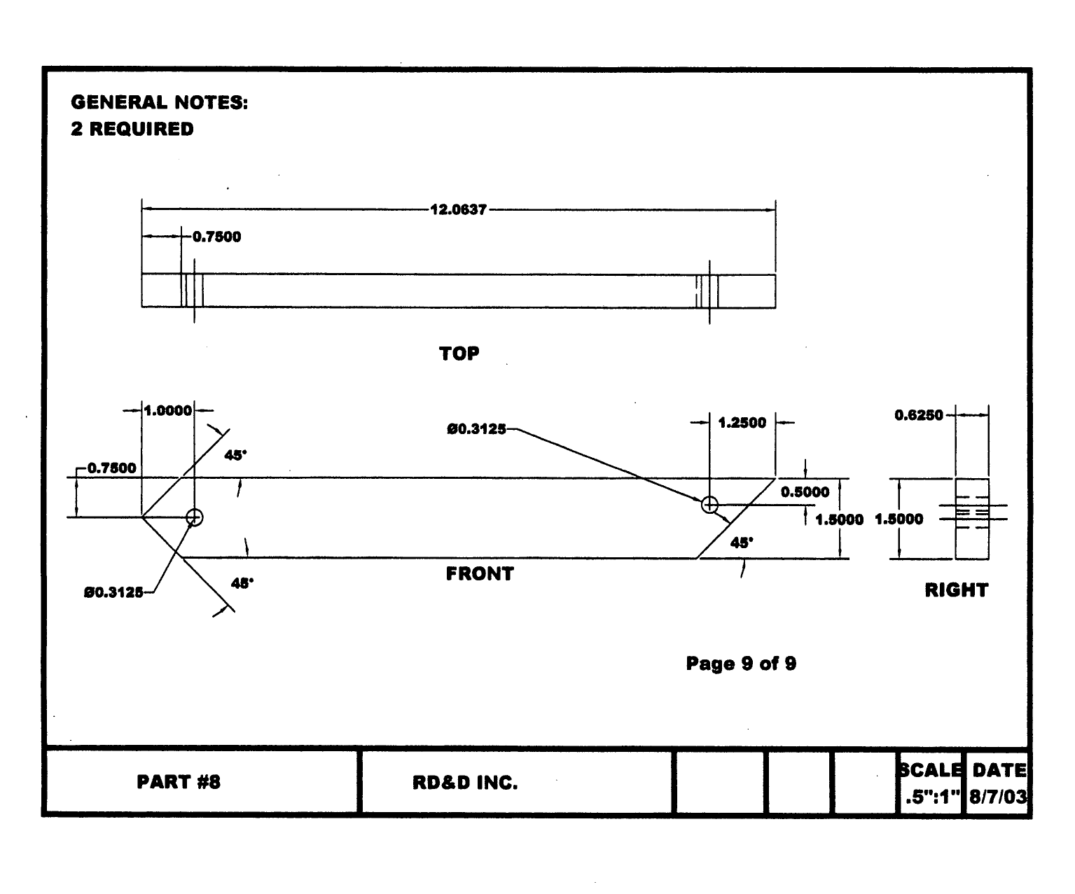

Inspiration: We were unsatisfied with the typical Game Feeder suspension systems currently on the market, which were not user friendly with respect to instillation time, number of people necessary to install and maintain as well as cost effectiveness.

What makes FEEDER EZ unique from other game feeder suspension systems currently available on the market?

### (OTHER SYSTEMS) EXAMPLES WHAT WAS DONE BEFORE

A. Tripod System (Bulky, Heavy, Time consuming to transport/Install, Difficult to fill/refill, barrel is held up off of the ground with three legs usually at a height of 6 to 8 feet)

B. Chain/Pulley System (Unable to support heavy loads, Could be hazardless, Difficult to install, barrel usually no heaver then 5 gallon bucket is pulled up over hanging branch of tree with a pulley system.)

C. Ground Troths (Can not control feeding times or amounts consumed by Game, Non cost effectiveness, Troth or large container is filled and left on ground for game to feed out of.)

D. Gravity Fed System (Can not control feeding times or amounts consumed by Game, Non cost effectiveness, Game can damage main body, feed is poured into a container that allows the product to travel down a tube into a feeding tray which is then replaced continuously as the game eats the Feed.)

Improvements

FEEDER EZ is a Unique System That is in (No Way) Similar to Any Other Feeder Suspension System Currently on the Market. Our System is Attached to the Trunk of a Tree and Hangs From a Tree While Supporting up to 300 lbs of Feed in a 30 or 55 Gallon Drums.

A. Feeder EZ is Installed in seconds (by one person) and ready to receive a barrel or grain holding Container within minutes, filled and operational within ten to fifteen minutes. The product is then dispensed by a timed throw system which is attached to the barrel for dispensing feed twice daily.

B. Light weight and durable feeder suspension system.

C. Extremely cost effective

D. Feeder Ez hangs from a tree with a chain on the top of system and the weight of any Barrel and product the barrel contains creates its holding strength on the tree. The chain then digs into the tree.

E. Diagrams and pictures have been provided.

Product Information, How it Works and or Claims

This is a light weight durable single piece aluminum feeder hanging system to hold 30 to 55 gallon drums or comparable waste containers converted into feeder systems for the purpose of feeding and provide nutrition's to wild game and domestic animals.

Feeder Ez is hung simply by placing feeder Ez against a tree and wrapping the chain around the tree and attaching to the other end of the chain to the S Hook at its closest and tightest link the weight of feeder ez and the added weight of the barrel and its Grain or Feed it contains adds pressure to the chain and causes the entire setup to push into and downward on the tree thus locking the Feeder Ez into place. The weight limit that has been assessed to the Feeder Ez is well over 300 Lbs. All prototypes currently in use have been filled to this capacity and show no signs of stress to any parts of the Feeder Ez.

Research of Similar Products

What research was done to qualify that this Idea is not already available on the Market? Researched Patent archives, Internet, catalogs, and stores for similar systems as well as a combined history of over 55 years of hunting Experience and found none. There is no other system that operates on the principals of Feeder Ez.

Feeder EZ—Materials and How Constructed

1. All Main Body parts consist of 60-61 Light weight Aluminum

2. Four inch Channel (1-Main Body Channel, 1-horizontal Barrel rest and 1-barrel retention support)

3. Two inch angle 2×2×¼″ (1-Main body chain support and 1-horizontal weight distribution angle)

4. 1½×3\8 flat bar (1-center barrel support and 2-Barrel rest supports/tree spikes)

5. 1″× 5/16″ Steal counter sink bolts/nuts 14 each

6. 2 each ⅜×1-½″ steal eye bolts and nuts

7. 1-4′ section of double brad chain

8. 2″ Steal S Hooks (2)

Parts List

Part #1

Part #2

Part #3

Part #4

Part #5

Part #6

Part #7

Part #8

Part #9

Part #10

Part #11

Part #12

1. Feeder EZ is a light weight durable single piece aluminum (feeder hanging system) that holds 30 to 55 gallon drums or comparable waist containers converted into feed dispensing systems for the purpose of feeding and provide nutrition's to wild game and domestic animals from any single tree trunk.
The Feeder EZ hanging system operates on the principle of placing Feeder EZ against a tree trunk and wrapping the chain around the tree and attaching to the opposite end of the Feeder EZ to the S hook at its closest and tightest link, the weight of the Feeder EZ and the added weight of the barrel and its Grain or Feed that it contains adds pressure to the chain and causes the entire setup to push into and downward on the tree thus locking the Feeder EZ hanging system securely into place on the tree.
